(19) United States
(12) Patent Application Publication
(10) Pub. No.: US 2024/0074421 A1
(43) Pub. Date: Mar. 7, 2024

(54) POPPING CORK HOLDING DEVICE

(71) Applicant: Bryan Hampton, Apopka, FL (US)

(72) Inventor: Bryan Hampton, Apopka, FL (US)

(21) Appl. No.: 17/902,333

(22) Filed: Sep. 2, 2022

(51) Int. Cl. A01K 97/06; A01K 93/00

(52) U.S. Cl. CPC A01K 97/06; A01K 93/00

(57) ABSTRACT

A popping cork holding device includes an elongated main body having a top surface, a bottom surface, a front surface and a back surface. A plurality of holes are positioned along the top surface and terminate into shoulders located inside the main body. Each of the holes include a shape and a size for receiving a bead located on a popping cork. A plurality of channels extend through the top surface, the bottom surface, the front surface and a portion of each hole and shoulder. Each of the channels includes a width for receiving the elongated rod portion of a popping cork. A plurality of individual popping corks are stored by the device by positioning a portion of the rod through a channel and lowering one of the beads into a hole in order to suspend the remainder of the popping cork beneath the bottom surface of the holder.

### TECHNICAL FIELD

The present invention relates generally to organizational devices, and more particularly to a holder for popping corks used in fishing.

### BACKGROUND

The statements in this section merely provide background information related to the present disclosure and may not constitute prior art.

In recent years, many fishermen have begun using a type of bobber called a popping cork. These devices include a generally oval-shaped cork having an elongated metallic rod extending from the top and bottom ends. A weight is positioned along the bottom portion of the rod, and a plurality of beads are located along the length of the rod. Loops are located on the top and bottom ends of the rod to engage a fishing line and a lead line, respectively. The device gets its name because during use the cork is jerked by the fishing pole causing the beads to make a sound similar to a prey fish, and the causing bait secured onto the lead line to move in a way that attracts a fish.

Although there is no shortage of commercially available tackle boxes, such devices are designed to function as a depository for a plurality of different fishing accessories such as hooks, bobbers, spare line, weights, lures and the like. Because these tackle boxes are designed to transition between an open and closed position, it can be hard for a fisherman to quickly locate particular items stored therein, especially in low light situations. With particular regard to popping corks, the elongated looped rods and the moving beads tend to constantly become tangled with other items stored inside the tackle box. This issue combined with a moving boat often results in great frustration to fisherman.

Accordingly, it would be beneficial to provide a popping cork holder that can be mounted onto a boat or other such area in order to allow a user to quickly and easily store and retrieve a plurality of popping corks so as to overcome the drawbacks described above.

### SUMMARY OF THE INVENTION

The present invention is directed to a popping cork holding device. One embodiment of the present invention can include an elongated main body having a top surface, a bottom surface, a front surface and a back surface. In one embodiment, a plurality of holes can be positioned along the top surface and can terminate in a shoulder located inside the main body. Each of the holes can include a shape and a size that is suitable for receiving a bead located on a popping cork.

In one embodiment, a plurality of channels can extend through the top surface, the bottom surface, the front surface and a portion of the hole and shoulder. Each of the channels can include a width that is suitable for receiving the elongated rod portion of a popping cork. A plurality of individual popping corks can be stored by the device by positioning a portion of the rod through the channel and lowering one of the beads into a hole so as to suspend the remainder of the popping cork beneath the bottom surface of the holder.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a popping cork holding device that is useful for understanding the inventive concepts disclosed herein.

FIG. 2 is a top view of the popping cork holding device in accordance with one embodiment of the invention.

FIG. 3 is a perspective view of the popping cork holding device in accordance with one embodiment of the invention.

FIG. 4 is a perspective view of the popping cork holding device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples include opposing strips of hook and loop material (i.e., Velcro®), attractively-oriented magnetic elements, flexible strips of interlocking projections with a slider (i.e., zipper), a thin, flexible strap with a notched surface and one end threaded through a locking mechanism (i.e., zip tie) at the other, tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

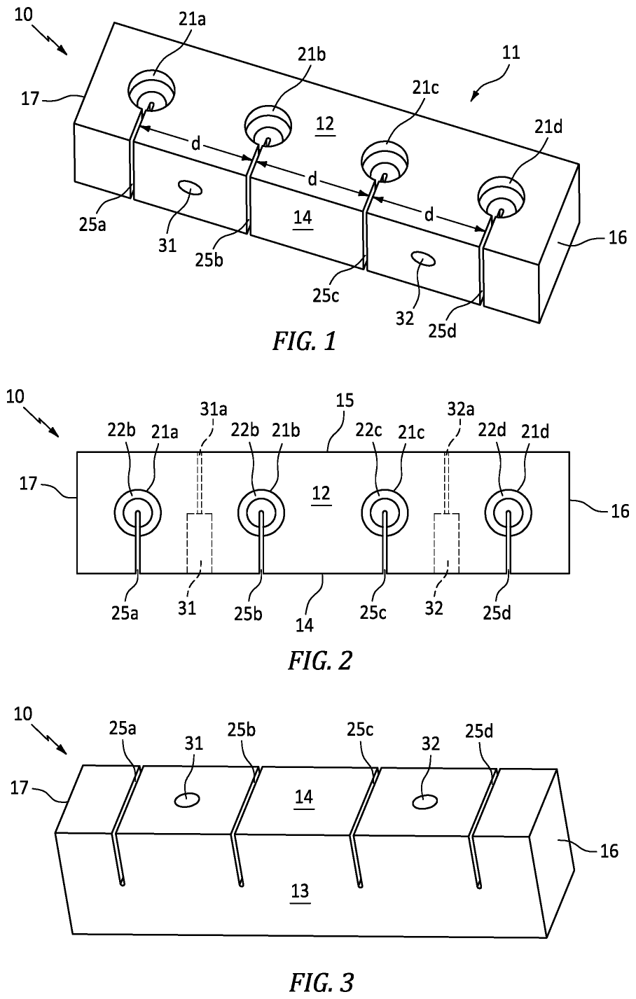

FIGS. 1-4 illustrate one embodiment of a popping cork holding device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

The device 10 can be adapted for attachment to a generally vertical surface of a fishing boat hull, console, seat or other such location. In one embodiment, the device can include an elongated generally rectangular-shaped main body member 11 having a top surface 12, a bottom surface 13, a front surface 14, a back surface 15 and a pair of sides 16 and 17.

As described herein, the main body 11 may be formed from materials that are suitable for damp/fishing environments and that are relatively strong and stiff for their weight. Several nonlimiting examples include but are not limited to various metals or metal alloys (e.g., aluminum, titanium, or alloys thereof), plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.).

In one embodiment, a plurality of holes 21a, 21b, 21c and 21d can be bored into the top surface 12, and can include shoulders 22a, 22b, 22c and 22d, respectively, located within the main body. In the preferred embodiment, each of the holes can be positioned along the middle of the main body (e.g., equidistantly between the front surface 14 and the back surface 15) and can each include both a diameter and a shoulder depth (e.g., distance between top surface 12 and the shoulder) of about ¼ inch. This dimension being complementary to the shape and size of the beads 2 that are positioned onto the rod 3 of a popping cork 5. Of course, any number of other dimensions are also contemplated.

In one embodiment, a plurality of elongated hollow channels 25a, 25b, 25c and 25d can extend from the front surface 14 to the middle of each of the shoulders 22a, 22b, 22c and 22d, respectively. As shown, the channels can extend through the entire height of the main body 11 so as to also extend through the top and bottom ends 12 and 13, respectively, of the main body. In the preferred embodiment, each of the channels can include a width of about 1/16 of an inch which corresponds to the width of the rod 3 of the popping cork.

In the preferred embodiment, the main body can include a width (e.g., distance between sides 15 and 16) of about 6 inches. This dimension being suitable for providing a separation distanced of about 1.25 inches between each of the holes 21a, 21b, 21c and 21d. Such a dimension being suitable for receiving and storing four different popping corks 5 each having a cork 1 with a width of up to 1.5 inches, which is among the largest commercially available sizes. Of course, other embodiments are contemplated wherein the main body includes different dimensions so as to accommodate more or fewer individual corks.

In either instance, the main body can include mounting apertures 31 and 32 which can preferably comprise counterbore apertures located along the front surface 14 and extending through the back surface 15 at 31a and 32a, respectively. The mounting apertures functioning to receive fasteners 9 such as screws, for example, that allow the main body to be mounted onto the boat or other structure. Of course, other embodiments are contemplated wherein any number of different types of mounting hardware can be provided.

For example, any number of different types of connectors can be provided such as hook and loop material, for example, which can be secured along the back surface 15 for allowing the main body to be removably secured onto a secondary object.

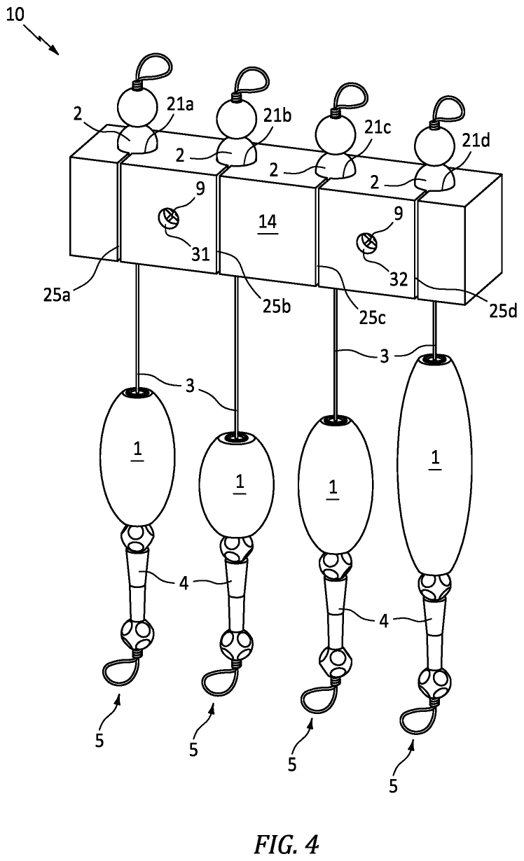

FIG. 4 shows one embodiment of the device 10 in operation. As shown, the device can be secured onto an exterior surface via the fasteners 9 and can function to receive and hold a plurality of different popping corks 5. Each individual popping cork can be held in place by first passing a portion of the elongated rod 3 located above the cork 1 horizontally though one of the channels 25a-25d. Next, the user can lower the popping cork until one of the beads 2 is located inside one of the holes. When so positioned, each popping cork will be held in place until removed by the user. Moreover, the design advantageously provides for the integrated weights 4 located along the bottom end of each popping cork to act to prevent the popping corks from bouncing up and falling out of the device 10 even on a moving and bouncing boat.

Accordingly, the above-described device provides a novel holder for popping corks to overcome the drawbacks noted above in a manner that is not rendered obvious by any known art.

As described herein, one or more elements of the popping cork holding device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A popping cork holding device, comprising:
an elongated main body having a top surface, a bottom surface, a front surface and a back surface;
a plurality of holes that are positioned along the top surface, each of the plurality of holes including a shoulder that is located beneath the top surface; and
a plurality of channels extending between the top surface and the bottom surface,
wherein each of the channels are in communication with one of the plurality of holes and includes a shape and a size that is configured to receive an elongated rod of a popping cork device.

2. The device of claim 1, wherein each of the plurality of holes includes a shape and a size that is complementary to a shape and a size of a bead located along the elongated rod of the popping cork device.

3. The device of claim 1, further comprising:
a pair of mounting apertures that extend between the front surface and the back surface of the main body.

4. The device of claim 3, wherein each of the pair of mounting apertures are configured to receive a connector for securing the main body onto a secondary object.

5. The device of claim 1, wherein the main body is constructed from a moisture resistant material.

6. The device of claim 1, wherein the main body is constructed from plastic.
